(19) United States
(12) Patent Application Publication
(10) Pub. No.: US 2019/0386963 A1
(43) Pub. Date: Dec. 19, 2019

(54) 2-dimensional Absolute Random and Automatic Encryption of Digital Data

(71) Applicant: Luwei Shi, Oberursel (DE)

(72) Inventor: Luwei Shi, Oberursel (DE)

(21) Appl. No.: 16/012,235

(22) Filed: Jun. 19, 2018

(51) Int. Cl. H04L 29/06; H04L 9/08; G06F 21/60

(52) U.S. Cl. CPC H04L 63/0428; G06F 21/602; H04L 9/0869

(57) ABSTRACT

By using certain natural sources as data input, absolute randomness can be reached. This invention focuses on the use of randomly captured photograph from one natural source (Wind Movements) as one working process example, to generate absolutely random, scalable (0, 1)-bit-string as high-safety encryption key. This invention's absolute random and automatic encryption can be best used for all digital data communications, and for digital devices privacy.

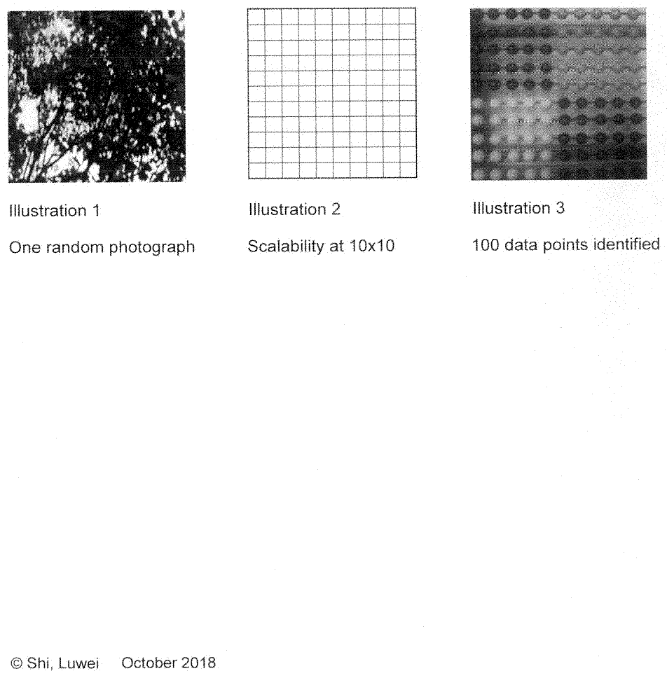

Additionally, this invention provides one specific asymmetric encoding rule, which enables solid implementation of encryption by using the absolute randomly generated encryption key so that any digital data on any digital device can be very safely encrypted.

### 1. BACKGROUND OF THIS INVENTION

### 1.1. From Digital Devices to (0, 1)-Bit Encryption Key

In today's digital world, human life is surrounded with plenty of digital devices, e.g. Mobile phones, Computers, Digitalised televisions, Digitalised smart appliances for various business and private household areas, etc.

These digital devices all come at least with a processor and a memory chip card, some with much more sophisticated equipment parts additionally.

On the other side, bank cards, credit cards and various customer cards are usually equipped with dedicated chip cards, which store important customer data. Once a card is in use, meaning through certain transaction, respectively related processor would then be able to retrieve these important digital data from the chip card. In this way, chip cards with external stationary processors working together is comparable to digital devices with chip cards and processors.

Therefore, both digital devices and cards equipped with memory chips have one feature in common:

Their working procedures are able to proceed stored digital data, which could be coded in many different ways, e.g. ANSI, ASCII, Hexadecimal, and Alphabet-Numerical, etc., while software packages are made in various programming languages.

By going through processors' working procedures, all these codes would then become just digital bits of (0, 1), which is actually the binary digital data all devices are effectively working with.

This knowledge would become an important start for this invention to reach compound data security purposes, which, though reasonably simple, so far have not yet been identified in the market:
(1) For high-safety data communication purpose, to create an absolute randomly and automatically generated (0, 1)-bit string, to replace the unsafe user manual access key entries for digital device access authorisation and to encrypt the entire running binary digital data any device regularly processes, for the time as long as device's user requires.
(Main purpose: high-safety encryption of digital device access authorisation and digital data communication of any digital device)
(2) For high-safety device privacy purpose, to create an absolute randomly and automatically generated and un-decrypt-able (0, 1)-bit string to repeatedly consume the on-device processor's work (one must consider that one device not in work could still be used for data communication in background without agreement of the user of that device) for certain amount of time as device's user requires (“Timer effect”, Side effect purpose: temporary shield of digital data communication of any digital device).

### 1.2. Current Market Situations about Data Security Methods of Digital Devices

In terms of digital data communication and digital device access authorisation, traditional and current market practises usually include either passwords/passcodes or additional physical identification devices or as a combination of the both.

These methods have been used since many decades, and have increasingly reached their limitations, particularly in a fast pacing modernised world during the recent years.

Passwords/passcodes, once can be seen, would then be compromised. This is unfortunately a problem not only for long-time user passwords, pins, etc., but also for temporary passwords/passcodes or one-off tans.

Additional physical identification devices could also be compromised during manufacturing processes or through unauthorised physical accesses or illegal copies of these devices. Biometric data stored on physical devices and used as access authorisation have similar problems. Therefore whether the use of fingerprint as access authorisation in today's world is still appropriate is seriously questionable.

Quantum encryption is scientific-methodologically very promising, but seems to be either very complicated or very expensive by deploying quantum computational technology. Once ready, there is a good reason to guess that this technology will not reach the volume market within foreseeable time period.

In compare to all these digital data security methods, this invention provides a highly efficient, absolutely safe, surprisingly low-cost, data encryption methodologic working process as a solution for all digital devices, among others in particular to solve the problems related with user relevant interactive device access safety in the volume market, as well as high safety encryption of the entire data communication of digital devices.

### 2. SUMMARY OF THIS INVENTION

This invention intends to provide a high-safety, high-efficiency, low-cost, digital encryption methodologic working process to all digital devices in the volume market. (Claim 1)

By using certain natural sources as data input, absolute randomness can be reached, as scientific simple proof can ensure. This invention focuses on the use of randomly captured photograph from one natural source (Wind Movements) as one working process example, to illustrate the results of this random encryption. However, some other appropriate natural sources can also be used as data input, for going through this same methodological idea and a generically much comparable working process to reach similar absolutely random encryption results. (Claim 1)

By deploying this methodologic working process, device hardware manufactures and device software developers will be in the position to integrate this very straightforward digital encryption working process into various appropriate (public or private) encryption-APIs within each device, in order to replace user manual encryption key entries (log-ins, passwords/passcodes, pin/tan, etc.) for automatic processing of digital device access authorisation. (Claim 1)

With these a-little-effort-API-modifications in digital devices, this methodologic working process can be well accepted into each and every device to create absolutely random, completely automatic, digital encryption for all digital data communication located on each device. (Claim 1)

By using this same methodologic working process, with a reduced natural sources-based randomness, some simplified variants could make the methodological deployment to one device even easier, however with some compromise on safety aspects. (Claim 1)

This invention also provides a simple digital encoding method, which is very easy to use and computationally non-disrupt-able, and differs with significant effects from other encoding methods in the market. (Claim 2)

This encoding method supports dedicatedly the high-safety encryption key of this invention to fulfil the desired invention purposes to very sufficiently encode and decode all digital data of any required devices. (Claim 2)

### 3. DESCRIPTION OF THIS INVENTION

### 3.1. Methodologic Working Process for Generating One Absolute Random Encryption Key

The encryption methodologic working process of this invention uses various natural sources, which intent to reach unforeseeable, unpredictable, un-reproduce-able computational data source from a mathematic-statistic viewpoint.

Some considerable sample natural sources are for instance Wind movements, Raindrops on the water surface, Pattern of cloud (for invention deployment in the aviation industry), Temperature changes, Brightness/daylight changes, etc. However, some natural sources as data input for absolute randomness would require modified working procedures to reach the demanded (0, 1)-bit string as encryption key, while some other natural sources as data input can use the same or similar working process as this invention provides.

In this invention document, the introduced methodologic working process focuses mainly on the example where Wind Movements have been taken as the data input for absolute randomness, to influence the content of a random photograph. While most of digital devices in the market today can take photos, this provides a very good base for the deployment and possible commercial success of this High-Safety Encryption Methodologic Working Process.

The methodologic working process starts at first in the most restrictive way to introduce the absolute-randomness based encryption, which is suggested for mobile digital devices with photo camera features. Then some simplified (less restrictive) variations will be introduced, which could be more interesting for many of the digital devices with reduced safety requirements.

The methodologic working process of this invention is described in details as the following:

(1)

Assuming a mobile digital device takes a random photograph in certain way, the device then transmits the photograph into black-white format. In the example the original photograph below Illustration 1 is taken on a windy day in early summer 2017, where wind movements significantly and randomly influenced leaves of a tree.

This resulted photograph is unforeseeable, unpredictable and un-reproduce-able, within the scientific-methodological frame of this document.

(2)

The photograph is to be reformatted with certain scalability, e.g. 10×10, 100×100, etc. For example, Illustration 2 below shows a scalability of 10×10. The selection of scalability could be a user-definable procedure or on-device manufacture pre-defined procedure. Manufactures could also introduce their own scalability rules to improve their product competitiveness in the market. This will also increase the data safety aspects, assuming the honesty and trust devices manufactures earn in the volume market.

(3)

Once scalability is defined, the black-white photograph is then be able to be turned into a gridded data point format. Each random photograph becomes either a small scale or a large scale data point format as user likes.

The following illustrations show this working procedure with a scalability of 10×10:

Illustration 1 One random photograph

Illustration 2 Scalability at 10×10

Illustration 3 100 data points identified

(These Illustrations are provided with the separate document “Drawings” for this invention.)

(4)

The next step is to turn the reached data point format into the demanded (0, 1)-bit string. One very important parameter as Lightness/Darkness-ratio needs to be introduced, which could be either on-device manufacture pre-defined procedure or user-defined, given the high significance of this parameter.

For every cell of the reformatted graph of a black-white photograph (Illustration 2), the device software is required just simply to recognise “black” or “white” according to a pre-defined Lightness/Darkness-ratio. This invention assumes that:

if one cell is recognised as “Black”, then the respectively corresponding gridded data point is “1”;

if one cell is recognised as “White”, then the respectively corresponding gridded data point is “0”.

(Other implementations following the same logic are possible.)

While this pre-defined Lightness/Darkness-ratio is highly important for this working process, there is a little complexity involved for setting this parameter.

If this parameter is on-device manufacture pre-defined, then it might need to be market-regulated e.g. at an agreed particular percentage, in order to avoid unnecessary suspicion in market.

If this parameter is user-definable, then the user probably should be given a selection interval e.g. between 20% and 80%, because for instance 100% or 0% of lightness would make the then generated bit strings as all-0 or all-1 and useless for the purpose of this methodologic working process. Another aspect is that if user could select a certain percentage, e.g. 46.7891%. However, only 46% shall be displayed on screen. The numbers after decimal is hidden. For large-scale situations, it's reasonable to assume that at least one (0, 1)-bit of one data point could be influenced through this small technic improvement. This would be enough to ensure the absolute randomness of the then generated (0, 1)-bit-string.

Once this parameter setting is done, the entire gridded data point format is to be turned into a (0, 1)-bit string, by applying the above mentioned digital string recognition rule:

One gridded data point measured in Black means 1,

One gridded data point measured in White means 0.

For instance, 10×10 gridded data point format becomes a 100 bit-digital-string, 100×100 gridded data point format becomes a 10,000 bit-digital-string.

### EXAMPLE

(1) One random photograph (with Wind movements as nature source data input) is taken.
(2) Scalability is defined: 4×4
(3) Gridded data point format: 16 data points to be decided as either black or white, either 1 or 0.
(4) Lightness/Darkness ratio: defined at 50%, means within one single grid cell, if darkness above 50%, this grid cell becomes 1, otherwise 0 (as an example implementation).

Result: 1110101100110101, a 16 bit-digital-string.

The then reached result is the absolute randomly and automatically generated digital encryption key via a random photograph. This seemingly very simple method provides the following mathematic-statistic meaning to get qualified as High-safety, High-efficiency, and Low-cost digital encryption key:

For example, without knowing one randomly generated 100 bit-digital-string, by using super computers to capture the right combination of this digital string, the probability is calculated as follows.

From the super computers' viewpoint, an unknown 100 bit-digital-string comes with 2¹⁰⁰, approximately 1.2676×10³⁰ possible digital combinations (10,000 bit digital strings means approximately infinity combinations).

In current market (market study done during 2016 and early 2017), world's most powerful super computer is measured with 93 Petaflops/s (93×10¹⁵ Operations per second), data source 2016 and 2017 (www.top500.org). (Any other computer performance measures or notations in more recent time probably will not change the results of this comparison, as documented below.)

For instance, during a 20-hours flight, which supposed to be the longest single non-stop flight known in today's aviation market, the following can be calculated by using the world's most powerful super computer:

20 hours×60 minutes×60 seconds×93×10¹⁵ Operations per second=6.696×10²¹ operations in total

In compare to the required amount of operations (approximately 1.2676×10³⁰ for 100 bit-digital-string) in order to decrypt this 100 bit-digital-string with certainty, the mathematic-statistical probability is very low that this 100 bit-digital-string can ever be decrypted during such a 20-hour flight, given significant discrepancy in numerical orders.

If by using the same method, but to reduce the user-definable time interval for generating a random photograph from 20 hours to 2 hours, means every 2 hours there will be a new random photograph generated and used, or even to 20 minutes or to 10 minutes or to 5 minutes. Then it can be absolutely ensured that it becomes impossible to decrypt such a 100 bit-digital-string key while such a random photograph is in use.

On the other side, if just applying the same photograph material, and by re-defining the scale of the photograph e.g. from 10×10 to 16×16 or to 20×20 or to 100×100, it is understandable that decryption of such digital-string keys would also become mathematically increasingly impossible, even by using the world's most powerful super computers.

One more sophisticated improvement of this methodologic working process would be to have multiple photographs captured within a certain time interval overlapping together. This is particularly useful, (a) when the natural conditions used as a random source is not volatile enough to generate significant random moves, or (b) by overlapping automatically selected photographs during a time interval, the then generated digital-string key would become even more random.

Based on the description above, one can easily ensure that the scientific proof for generating this absolute random encryption key is given.

### 3.2. Methodologic Working Process for High-Safety Encryption of Digital Data

In order to deploy this absolute random encryption key to fulfil the intended purposes of this invention (refer to section 1.1.), one particular encoding rule is needed. After some R&D work, one very simple encoding rule has been defined as a part of this invention, which differs with significant effects from other encoding methods in the market.

The encoding rule defined by this invention, and used for this encryption methodologic working process is the following:

0+0=0, 1+1=0,

0+1=1, 1+0=0,

with no overflow allowed.

In this encoding rule, two different combinations of additive bits with respectively the same results 0 or 1 make sure that the entire encoding rule is computationally qualified. More importantly, one part of this encoding rule “with no overflow allowed” distinguishes this encoding rule significantly from other encoding methodologies in the market, and makes this invention's entire working process highly efficient, with no overlapping to other available data encryption methodologies in market.

The following illustrates with details how this encoding (and decoding) rule works:

### EXAMPLE

To be encrypted digital data: . . . 10111001100011111010 . . .

100 bit-digital-string key: . . . 11100010101001111101 . . .

Result: . . . 01011011001010000111 . . .

By using the absolutely randomly generated encryption key (if required, repeatedly, within a user defined time interval, which is out of the reach of decryption capacity of super computers) and applying the encoding rule of this invention as described above, any digital data on any digital device can be very safely encrypted, in order (a1) to ensure high-safety user device access authorisation as well as (a2) to ensure high-safety user data communication, and in order (b) to ensure absolute device privacy temporarily within specified timeframe.

Relevant to the purpose (a2), in order to absolute safely transfer digital data, the original random digital encryption key will need to be automatically submitted to the communication partner. This can be done by using various sophisticated telecommunication technics, which are not within the scope of this invention.

### 3.3. Methodologic Working Process for Generating Less Restrictive Random Encryption Key

While having introduced the most restrictive way of absolute random encryption, the following simplified less restrictive way of taking a random photograph can be considered.

Any device which has a photo taking feature in any in-door or out-door situations could take a random photograph without proving the involvement of a nature source.

For instance, a Pad-tablet could take a photograph in the middle of one large commercial shopping area, a Web-cam installed at one of most busy city areas could take a photograph, and it has been formally reported in the market that even a Coffee automate has the ability to take a photograph, etc.

Considering, if such a photograph goes through the same working process to generate an encryption key as introduced above in this invention document. Absolute randomness is then not given, thus the question to be answered is how less qualified such an encryption key would become. The answer might be found in 2 folders:
1) In mathematic-statistical understanding, the concern would be e.g. that exactly the same photograph could be re-captured or re-produced (in particular e.g. in in-door stationary situations). This could make such a photograph disqualified as a safety encryption key.
2) Another concern is more in the ethic and social-political areas that any objects related to privacy of others should not be used without permission. This problem would then probably require additional work to anonymise some content of such a photograph, as long as the Lightness/Darkness-ratio is quantitatively (mathematically) not effected.

This simplified, less restrictive approach provides some variants in compare to the absolute randomness-based methodologic working process. These variants could be considered as encryption key with reduced safety, but also with extreme low-cost from a technical and commercial viewpoint.

1: Methodologic working process of automatically generating and using absolute random encryption keys for digital data of all digital devices
This invention's absolute random and automatic encryption methodologic working process, with its high efficiency and inexpensive cost, can be best used principally for all digital data communications. This invention can help completely eliminate the safety issues linked with user access authorisation of digital devices, automatically and absolute safely encrypt all digital data on any user devices.
Given the absolute randomness of this encryption methodologic working process, this invention can be used among others in 2 different ways:
Solution 1
To absolute safely transfer digital data, by automatically submitting the original random digital encryption key to the communication partner. (Although, telecom communication protocol technics are not within the scope of this invention.)
For high-safety data communication, to create an absolute randomly and automatically generated digital encryption key, to replace the unsafe user manual access key entries for digital device access authorisation, and to encrypt the running binary digital data any device regularly processes, for the time as long as device's user requires.
(Main purpose: high-safety encryption of digital device access authorisation and digital data communication of any digital device.)
Solution 2
To block the data transmission of digital devices/digital telecom services for a particular time frame while not disclosing the original random digital encryption key on-device.
For high-safety device privacy, to create an absolute randomly and automatically generated and un-decrypt-able digital encryption key to repeatedly consume the device processor's work (one must consider that one device not in work could still be used for data communication in background without agreement of user of that device) for certain amount of time as device's user requires.
(“Timer effect”, Side effect purpose: temporary shield of digital data communication of any digital device).

2: Encoding rule for high-safety encryption of digital data
As a very important supporting method for this invention's main claim (claim 1), the encoding rule documented in this invention document (claim 2) enables solid and reliable implementation of encryption by using the absolute randomly generated encryption key (if required, repeatedly, within a user defined time interval, which is out of the reach of decryption capacity of super computers), so that any digital data on any digital device can be very safely encrypted.
This encoding rule as a specific encoding method of this invention distinguishes carefully from some other market encoding methods. Measured by the absolute solid encrypted results, this encoding rule is well qualified as a separate claim to the main claim 1 of this invention, based on computational technological understandings.
Deployment of this invention: Use case samples
Based on the detailed introduction of this 2-dimensional absolute random automatic encryption methodologic working process, some use case samples can be suggested, while many possibilities could be easily derived from these samples.
(1) High-safety encryption supported digital data transmission of all digital devices.
On a single device basis, absolute randomness based digital encryption key replaces user manual entry of device security login data on the device, where sensitive digital data will then be encrypted via this digital encryption key instead of the possibly compromised user security data (passwords/passcodes, pins, tans, etc.). Once the absolute random encryption key is submitted to communication partner, the entire digital data communication is encrypted with high-safety.
(2) High-safety encryption supported digital data transmission of telecommunication services.
Not necessarily related with any single device, this automatically generated absolute randomness based digital encryption key provides a highly efficient and extreme low-cost encryption alternative choice for telecommunication providers, in compare to telecom industry's other standard encryption methodologies.
(3) High-safety encryption supported digital data transmission of all electro-magnetic waves (mainly related to empowering equipment) which carry more wave features than particle features. (referring to long waves, wave length above daylight)
To encrypt electronic waves with particle features (the lightening short waves) is more challenging. However, even for waves with particle features, there need to be digital devices which capture and receive the resulting digital data. These digital receiver devices could then be sufficiently encrypted by using this encryption methodologic working process.
(4) High-safety encryption supported Private cloud/Private WLAN/Private hotspot
To provide timed privacy area, where significantly powered private device network wave with un-decrypt-able key could shield a particular area with no data communication for certain period of time as required.
